(19) United States
(12) Patent Application Publication
(10) Pub. No.: US 2006/0122325 A1
(43) Pub. Date: Jun. 8, 2006

(54) Blends having improved properties

(76) Inventors: Eckhard Wenz, Koln (DE); Thomas Konig, Leverkusen (DE); Thomas Eckel, Dormagen (DE); Herbert Eichenauer, Dormagen (DE); Holger Warth, Dormagen (DE); Bernd Urbanneck, Monchengladbach (DE)

Correspondence Address: BAYER MATERIAL SCIENCE LLC, 100 BAYER ROAD, PITTSBURGH, PA, 15205, US

(21) Appl. No.: 10/536,710

(22) PCT Filed: Nov. 17, 2003
(86) PCT No.: PCT/EP03/12806

§ 371 Date: May 27, 2005

(30) Foreign Application Priority Data
Nov. 29, 2002 (DE) 10255825.6

(51) Int. Cl. C08L 51/00; C08L 77/00

(52) U.S. Cl. 525/64; 525/67; 525/66

(57) ABSTRACT

The present invention relates to thermoplastic blends modified with special co- precipitation products, a process for producing them and moulded parts manufactured from them.

The present invention relates to thermoplastic blends modified wi special co- precipitation products, a process for producing them and moulded bodies manufactured from them.

Thermoplastic moulding compositions of polycarbonates and ABS polymers have long been known. Thus DE-A 1 170 141 discloses readily processable moulding compositions consisting of polycarbonates and graft polymers of monomer mixtures of acrylonitrile and an aromatic vinyl hydrocarbon on polybutadiene.

DE-A 1 810 993 highlights the improved resistance to heat distortion of polycarbonates in mixture with ABS graft polymers or copolymers based on a- methyl styrene.

DE-A 2 259 565 and DE-A 2 329 548 provide the improved joint line strength of PC/ABS moulding compositions, both specifications using graft polymers with a particular particle size as a constituent of the ABS component.

DE-A 2 818 679 discloses that PC/ABS mixtures have particularly high low- temperature toughness if the ABS polymer contains two graft mixed polymers with a differing degree of grafting.

The filtration of polymer latices to remove impurities or coarse particles is known from the prior art. Thus for example, Houben Weyl XIV/1, Makromolekulare Stoffe 1, pages 348 to 356 (Georg Thieme Verlag, Stuttgart, 1961) and DE-A-4 126 483 and US-A-4 747 959 disclose the filtration of rubber latices. Connections with the mechanical properties are not known from this prior art.

Thermoplastic moulding compositions with a particle diameter of 0.20 to 0.35 μm are known from EP-A-0 704 488.

The object of the present invention is to provide blend compositions modified with impact-resistance, which have an optimised combination of properties consisting of very good surface quality (in particular a very low number of defects, known as “speckling”) good flow behaviour and very good toughness with no negative effects on the stress cracking resistance (ESC behaviour).

The compositions may also be provided with flame-resistance by means of flame retardants. Compositions modified with impact resistance and provided with flame resistance are particularly suitable for thin-wall applications such as e.g. Notebooks.

It was found, that polycarbonate compositions modified with impact resistance, which contain a special mixture of at least one graft polymer and at least one thermoplastic vinyl (co)polymer obtained by co-precipitation, have the desired properties.

The invention thus provides compositions containing
A) a thermoplastic or a mixture of thermoplastics selected from at least one from the group of polycarbonates, polyestercarbonates, polyamides, polyalkylene terephthalates and polyoxymethylene,
B) a mixture, obtained by co-precipitation, of at least one graft polymer B.1 produced by emulsion polymerisation and at least one thermoplastic vinyl (co)polymer B.2 produced by emulsion polymerisation and
C) at least one thermoplastic vinyl (co)polymer produced by solvent- mass- or suspension polymerisation.
   Compositions Containing
A) 10 to 99, preferably 20 to 98.5, in particular 30 to 98 parts by weight thermoplastic or a mixture of thermoplastics selected from at least one from the group of polycarbonates, polyestercarbonates, polyamides, polyalkylene terephthalates and polyoxymethylene,
B) 0.5 to 90, preferably 1.5 to 80, in particular 2 to 70 parts by weight of a mixture obtained by co-precipitation of at least one graft polymer B.1 produced by emulsion polymerisation and at least one thermoplastic vinyl (co)polymer B.2 produced by emulsion polymerisation,
C) 1 to 50, preferably 1 to 45, in particular 1 to 40 parts by weight of at least one thermoplastic vinyl (co)polymer produced by solution-, mass- or suspension polymerisation,
D) 0 to 20, preferably 0 to 18, in particular 0 to 16 parts by weight flame retardants,
E) 0 to 5 parts by weight fluorinated polyolefin. are preferred.

These constituents and other components that may be used in the compositions according to the invention will be explained below by means of examples.

Component A

Polycarbonates and aromatic polyestercarbonates that are suitable according to component A of the invention are known from the literature or may be produced by processes known from the literature (for the production of aromatic polycarbonates see for example Schnell, “Chemistry and Physics of Polycarbonates”, Interscience Publishers, 1964 and also DE-AS 1 495 626, DE-A 2 232 877, DE-A 2 703 376, DE-A 2 714 544, DE-A 3 000 610, DE-A 3 832 396; for the production of aromatic polyestercarbonates, e.g. DE-A 3 077 934).

Aromatic polycarbonates are produced, e.g. by melt processes or by reacting diphenols with carbonic acid halides, preferably phosgene and/or with aromatic dicarboxylic acid dihalides, preferably benzene dicarboxylic acid dihalides, by the phase interface process, optionally using chain stoppers, for example monophenols, and optionally using tri-functional or more-than-tri-functional branching agents, for example triphenols or tetraphenols.

Diphenols for the production of the aromatic polycarbonates and/or aromatic polyestercarbonates are preferably those of formula (I) 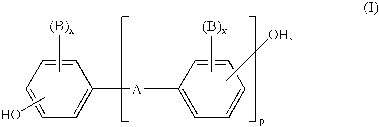
wherein
A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings, optionally containing heteroatoms, may be condensed,
   or a group of formula (II) or (III) 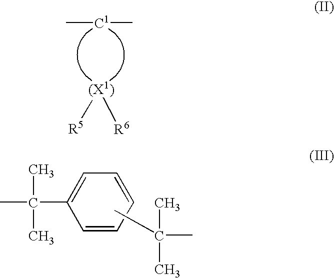
B is, in each case, C₁ to C₁₂-alkyl, preferably methyl, halogen, preferably chlorine and/or bromine
X is in each case, independently of each other, 0, 1 or 2,
p is 1 or 0, and
R⁵ and R⁶ may be selected individually for each X¹, independently of each other, as hydrogen or C₁ to C₆-alkyl, preferably hydrogen, methyl or ethyl,
X¹ means carbon and
m means an integer from 4 to 7, preferably 4 or 5, provided that R⁵ and R⁶ are both alkyl on at least one X¹ atom.

Preferred diphenols are hydroquinone, resorcinol, dihydroxy diphenols, bis- (hydroxyphenyl)-C₁-C₅-alkanes, bis-(hydroxyphenyl)-C₅-C₆-cycloalkanes, bis- (hydroxyphenyl)-ethers, bis-(hydroxyphenyl)-sulfoxides, bis-(hydroxyphenyl)- ketones, bis-(hydroxyphenyl)-sulfones and a,a-bis-(hydroxyphenyl)-diisopropyl benzenes as well as their core-brominated and/or core-chlorinated derivatives.

Particularly preferred diphenols are 4,4′-dihydroxy diphenyl, bisphenol A,2,4-bis(4- hydroxyphenyl)-2-methylbutane, 1,1-bis-(4-hydroxyphenyl)-cyclohexane, 1,1-bis- (4-hydroxyphenyl)-3,3,5-trimethylcyclohexane, 4,4′-dihydroxy diphenyl sulfide, 4,4′-dihydroxy diphenyl sulfone and their di- and tetrabrominated or chlorinated derivatives such as for example 2,2-bis(3-chloro-4-hydroxyphenyl)-propane, 2,2- bis-(3,5-dichloro-4-hydroxyphenyl)-propane or 2,2-bis-(3,5-dibromo-4- hydroxyphenyl)-propane. 2,2-bis-(4-hydroxyphenyl)-propane (bisphenol A) is preferred in particular.

The diphenols may be used alone or in any mixture. The diphenols are known from the literature or may be produced by processes known from the literature.

Suitable chain stoppers for the production of the thermoplastic aromatic polycarbonates are, for example, phenol, p-chlorophenol, p-tert-butylphenol or 2,4,6-tribromophenol but also long chain alkyl phenols such as 4-(1,3- tetramethylbutyl)-phenol according to DE-A 2 842 005 or monoalkyl phenol or dialkyl phenols containing a total of 8 to 20 carbon atoms in the alkyl substitutents, such as 3,5-di-tert-butylphenol, p-iso-octylphenol, p-tert-octylphenol, p- dodecylphenol and 2-(3,5-dimethylheptyl)-phenol and 4-(3,5-dimethylheptyl)- phenol. The quantity of chain stoppers to be used generally amounts to 0.5 mol.% to 10 mol.% in relation to the molar sum of the diphenols used in each case.

The thermoplastic, aromatic polycarbonates and polyestercarbonates have average weight-average molecular weights (M_{w}, measured e.g. by ultracentrifuge or light scattering measurement) of 10 000 to 200 000, preferably 15 000 to 80 000.

The thermoplastic aromatic polycarbonates may be branched in the known way, and preferably by the incorporation of 0.05 to 2.0 mol.% in relation to the sum of diphenols used, of trifunctional or more-than-trifunctional compounds, for example those containing three or more phenolic groups.

Both homopolycarbonates and copolycarbonates are suitable. 1 to 25 wt.%, preferably 2.5 to 25 wt.%, in relation to the total quantity of diphenols to be used, of polydiorganosiloxanes containing hydroxyaryloxy terminal groups may also be used for the production of copolycarbonates according to component A of the invention. These are known (U.S. Pat. No. 3,419,634) and can be produced by processes known from the literature. The production of polydiorganosiloxane-containing copolycarbonates is disclosed in DE-A 3 334 782.

Preferred polycarbonates are, in addition to the bisphenol A homopolycarbonates, the copolycarbonates of bisphenol A containing up to 15 mol.%, in relation to the molar sum of diphenols, of diphenols other than those stated as preferred or particularly preferred, in particular 2,2-bis(3,5-dibromo-4-hydroxyphenyl)-propane.

Aromatic dicarboxylic acid halides for the production of aromatic polyestercarbonates are preferably the diacid dichlorides of isophthalic acid, terephthalic acid, diphenylether-4,4′-dicarboxylic acid and naphthalene-2,6- dicarboxylic acid.

Mixtures of the diacid dichlorides of isophthalic acid and terephthalic acid in a ratio of 1:20 to 20:1 are preferred in particular.

When producing polyestercarbonates, a carbonic acid halide, preferably phosgene, is also used as a bifunctional acid derivative.

In addition to the monophenols already mentioned, their chlorocarbonic acid esters and the acid chlorides of aromatic monocarboxylic acids, which may optionally be substituted by C₁ to C₂₂-alkyl groups or by halogen atoms, as well as aliphatic C₂ to C₂₂-monocarboxylic acid chlorides, are also possible chain stoppers for the production of the aromatic polyestercarbonates.

The quantity of chain stoppers is 0.1 to 10 mol.% in each case, in relation to mols diphenol in the case of the phenolic chain stopper, and mols of dicarboxylic acid dichloride in the case of the monocarboxylic acid chloride chain stopper.

The aromatic polyester carbonates may also contain incorporated aromatic hydroxycarboxylic acids.

The aromatic polyestercarbonates may be either linear or branched in the known way (see DE-A 2 940 024 and DE-A 3 007 934).

Tri- or polyfunctional carboxylic acid chlorides, such as trimesic acid trichloride, cyanuric acid trichloride, 3,3′-,4,4′-benzophenone-tetracarboxylic acid tetrachloride, 1,4,5,8-naphthalene tetracarboxylic acid tetrachloride or pyromellitic acid tetrachloride, in quantities of 0.01 to 1.0 mol.% (in relation to the dicarboxylic acid dichlorides used) or tri- or polyfunctional phenols, such as phloroglucinol, 4,6- dimethyl-2,4,6-tri-(4-hydroxyphenyl)-heptene-2,4,4-dimethyl-2,4-6-tri-(4- hydroxyphenyl)-heptane, 1,3,5-tri-(4-hydroxyphenyl)-benzene, 1,1,1-tri-(4- hydroxyphenyl)-ethane, tri-(4-hydroxyphenyl)-phenyl methane, 2,2-bis[4,4-bis(4- hydroxyphenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl phenol, 2-(4-hydroxyphenyl)-2-(2,4-dihydroxyphenyl)-propane, tetra-(4-[4- hydroxyphenyl-isopropyl]-phenoxy)-methane, 1,4-bis[4,4′-dihydroxytriphenyl)- methyl]-benzene, in quantities of 0.01 to 1.0 mol.% in relation to diphenols used, for example, may be used as branching agents. Phenolic branching agents may be provided with the diphenols, acid chloride branching agents may be incorporated together with the acid dichlorides.

The content of carbonate structural units in the thermoplastic aromatic polyestercarbonates may be varied at will. The content of carbonate groups is preferably up to 100 mol%, in particular up to 80 mol% and most preferably up to 50 mol% in relation to the sum of ester groups and carbonate groups. Both the ester and the carbonate content of the aromatic polyester carbonates may be present in the form of blocks or randomly distributed in the polycondensate.

The thermoplastic, aromatic polycarbonates and polyestercarbonates may be used alone or in any mixture.

Polyamides suitable according to the invention (according to component A) are known or may be produced by processes known from the literature.

Polyamides suitable according to the invention are known homopolyamides, copolyamides and mixtures of these polyamides. These may be partially crystalline and/or amorphous polyamides. Polyamide-6, polyamide-6,6, mixtures and corresponding copolymers of these components are suitable as partially crystalline polyamides. Partially crystalline polyamides of which the acid component consists wholly or partially of terephthalic acid and/or isophthalic acid and/or suberic acid and/or sebacic acid and/or azelaic acid and/or adipic acid and/or cyclohexane dicarboxylic acid, of which the diamine component consists wholly or partially of m- and/or p-xylylene diamine and/or hexamethylene diamine and/or 2,2,4-trimethyl hexamethylene diamine and/or 2,4,4-trimethyl hexamethylene diamine and/or isophorone diamine and the composition of which is known in principle, are also possible as partially crystalline polyamides.

In addition, polyamides may also be named that are produced wholly or partially from lactams containing 7 to 12 carbon atoms in the ring, optionally also using one or more of the above-mentioned starting components.

Particularly preferred partially crystalline polyamides are polyamide-6 and polyamide-6,6 and mixtures thereof. Known products may be used as amorphous polyamides. They are obtained by polycondensation of diamines such as ethylene diamine, hexamethylene diamine, decamethylene diamine, 2,2,4- and/or 2,4,4- trimethyl hexamethylene diamine, m- and/or p-xylylene diamine, bis-(4- aminocyclohexyl)-methane, bis-(4-aminocyclohexyl)-propane, 3,3′-dimethyl-4,4′- diamino-dicyclohexyl methane, 3-aminomethyl-3,5,5-trimethyl cyclohexyl amine, 2,5- and/or 2,6-bis-(aminomethyl)-norbornane and/or 1,4-diamino methyl cyclohexane with dicarboxylic acids such as oxalic acid, adipic acid, azelaic acid, decane dicarboxylic acid, heptadecane dicarboxylic acid, 2,2,4- and/or 2,4,4- trimethyl adipic acid, isophthalic acid and terephthalic acid.

Copolymers that are obtained by polycondensation of several monomers are also suitable, and furthermore copolymers that are produced with the addition of aminocarboxylic acids such as ε-aminocapronic acid, ω-aminoundecanoic acid or ω- aminolauric acid or lactams thereof.

Particularly suitable amorphous polyamides are the polyamides produced from isophthalic acid, hexamethylene diamine and other diamines such as 4,4-diamino dicyclohexyl methane, isophorone diamine, 2,2,4- and/or 2,4,4-trimethyl hexamethylene diamine, 2,5- and/or 2,6-bis-(aminomethyl)-norbornenes; or from isophthalic acid, 4,4′-diamino dicyclohexyl methane and ε-caprolactam; or from isophthalic acid, 3,3′-dimethyl-4,4′-diamino dicyclohexyl methane and lauric lactam; or from terephthalic acid and the isomer mixture of 2,2,4- and/or 2,4,4- trimethyl hexamethylene diamine.

Instead of the pure 4,4′-diamino dicyclohexyl methane, mixtures of the positionally isomeric diamino dicyclohexyl methanes may be used, which are composed of
70 to 99 mol.% of the 4,4′-diamino isomer
1 to 30 mol.% of the 2,4′-diamino isomer and
0 to 2 mol.% of the 2,2′-diamino isomer,
   optionally correspondingly higher condensed diamines, which are obtained by hydrogenation of technical grade diamino diphenyl methane. Up to 30% of the isophthalic acid may be replaced by terephthalic acid.

The polyamides preferably have a relative viscosity (measured on a 1 wt.% solution in m-cresol at 25° C.) of 2.0 to 5.0, in particular of 2.5 to 4.0.

Component A may contain the polyamides alone or in any mixture with each other.

Suitable polyalkylene terephthalates are reaction products of aromatic dicarboxylic acids or their reactive derivatives, such as dimethyl esters or anhydrides, and aliphatic, cycloaliphatic or araliphatic diols and also mixtures of these reaction products.

Preferred polyalkylene terephthalates contain at least 80 wt.%, preferably at least 90 wt.% in relation to the dicarboxylic acid component, of terephthalic acid groups, and at least 80 wt.%, preferably at least 90 mol.% in relation to the diol component of ethylene glycol- and/or butane diol-1,4 groups.

The preferred polyalkylene terephthalates may contain, in addition to terephthalic acid groups, up to 20 mol.%, preferably up to 10 mmol.% groups of other aromatic or cycloaliphatic dicarboxylic acids containing 8 to 14 C atoms or aliphatic dicarboxylic acids containing 4 to 12 C atoms, such as groups of phthalic acid, isophthalic acid, naphthalene-2,6-dicarboxylic acid, 4,4′-diphenyl dicarboxylic acid, succinic acid, adipic acid, sebacic acid, azelaic acid, cyclohexane diacetic acid.

The preferred polyalkylene terephthalates may contain, in addition to ethylene glycol or butane diol-1,4 groups, up to 20 mol.%, preferably up to 10 mol.%, of other aliphatic diols containing 3 to 12 C atoms or cycloaliphatic diols containing 6 to 21 C atoms, e.g. groups of propane diol-1,3,2-ethylpropane diol-1,3, neopentyl glycol, pentanediol-1,5, hexanediol-1,6, cyclohexane dimethanol-1,4, 3- ethylpentanediol-2,4, 2-methylpentanediol-2,4, 2,2,4-trimethylpentanediol-1,3, 2- ethylhexanediol- 1,3, 2,2-diethylpropanediol-1,3, hexanediol-2,5, 1,4-di-(β- hydroxyethoxy)-benzene, 2,2-bis-(4-hydroxycyclohexyl)-propane 2,4-dihydroxy- 1,1,3,3-tetramethyl-cyclobutane, 2,2-bis-(4-β-hydroxyethoxy-phenyl)-propane and 2,2-bis-(4-hydroxypropoxy-phenyl)-propane ) (DE-A 2 407 674, 2 407 776, 2 715 932).

The polyalkylene terephthalates may be branched by incorporating relatively small quantities of tri- or tetra-valent alcohols or 3- or 4- basic carboxylic acids, e.g. according to DE-A 1 900 270 and U.S. Pat. No. 3,692,744. Examples of preferred branching agents are trimesic acid, trimellitic acid, trimethylol ethane and -propane and pentaerythritol.

Polyalkylene terephthalates that are produced solely from terephthalic acid and its reactive derivatives (e.g. its dialkyl esters) and ethylene glycol and/or butane diol- 1,4, and mixtures of these polyalkylene terephthalates, are preferred in particular.

Mixtures of polyalkylene terephthalates contain 1 to 50 wt.%, preferably 1 to 30 wt.%, polyethylene terephthalate and 50 to 99 wt.%, preferably 70 to 99 wt.% polybutylene terephthalate.

The polyalkylene terephthalates preferably used generally have an intrinsic viscosity of 0.4 to 1.5 dl/g, preferably 0.5 to 1.2 dl/g, measured in phenol/o-dichlorobenzene (1:1 parts by weight) at 25° C. in an Ubbelohde viscometer.

The polyalkylene terephthalates may be produced by known methods (e.g. Kunststoff-Handbuch, Volume VIII, p. 695 ff., Carl-Hanser Verlag, Munich 1973).

Polyoxymethylenes are also equally suitable as Component A).

Component B

Component B comprises a mixture, obtained by co-precipitation, of at least one graft polymer B.1 produced by emulsion polymerisation of
i) 5 to 95, preferably 20 to 80 wt.%, particularly preferably 25 to 60 wt.%, in particular 30 to 50 wt.%, of at least one vinyl monomer on
ii) 95 to 5, preferably 80 to 20 wt.%, particularly preferably 75 to 40 wt.%, in particular 70 to 50 wt.%, of one or more grafting bases having glass transition temperatures <10° C., preferably <0° C., particularly preferably <-20° C.
   and at least one thermoplastic vinyl (co)polymer B.2, produced by emulsion polymerisation, built up from monomers i).

The grafting base (ii) generally has an average particle size (d₅₀ value) of 0.05 to 5 μm, preferably 0.10 to 0.5 μm, particularly preferably 0.20 to 0.40 μm.

Monomers i) are preferably mixtures of
i1) 50 to 99 parts by weight vinyl aromatics and/or core-substituted vinyl aromatics (such as for example styrene, a-methylstyrene, p-methylstyrene, p- chloro styrene) and/or (meth)acrylic acid-(C₁—C₈)-alkyl esters (such as e.g. methyl methacrylate, ethyl metacrylate) and
i2) 1 to 50 parts by weight vinyl cyanide (unsaturated nitrites such as acrylonitrile and methacrylonitrile) and/or (meth)acrylic acid-(C₁—C₈)-alkyl esters (such as e.g. methyl methacrylate, n-butyl acrylate, t-butyl acrylate) and/or derivatives (such as anhydrides and imides) of unsaturated carboxylic acids (for example maleic acid anhydride and N-phenyl maleimide).

Preferred monomers i1) are selected from at least one of the monomers styrene, α- methyl styrene and methyl methacrylate, preferred monomers i2) are selected from at least one of the monomers acrylonitrile, maleic acid anhydride and methyl methacrylate.

Particularly preferred monomers are i1) styrene and i2) acrylonitrile.

Suitable grafting bases ii) for the graft polymer B.1 are for example, diene rubbers, EP(D)M rubbers, in other words those based on ethylene/propylene and optionally diene monomers, also acrylate-, polyurethane-, silicone-, chloroprene- and ethylene/vinyl acetate rubbers.

Preferred grafting bases ii) are diene rubbers. Diene rubbers according to the present invention are diene rubbers (e.g. based on butadiene, isoprene etc.) or mixtures of diene rubbers or copolymers of diene rubbers or mixtures thereof with other copolymerisable monomers (e.g. according to i1) and i2)), preferably butadiene- styrene copolymers, preferably containing up to 30 wt.% styrene , provided that the glass transition temperature of component ii) is <10° C., preferably <0° C., in particular <−20° C.

Pure polybutadiene rubber is preferred in particular.

Suitable acrylate rubbers according to ii) of polymer B.1 are preferably polymers of acrylic acid alkyl esters, optionally containing up to 40 wt.% in relation to ii) of other polymerisable, ethylenically unsaturated monomers. The preferred polymerisable acrylic acid esters include C₁—C₈-alkyl esters, for example methyl-, ethyl-, butyl-, n-octyl- and 2-ethylhexyl esters; halogen alkyl esters, preferably halogen-C₁—C₈-alkyl esters, such as chloro ethyl acrylate and mixtures of these monomers.

For the purpose of crosslinking, monomers having more than one polymerisable double bond may be copolymerised. Preferred examples of crosslinking monomers are esters of unsaturated monocarboxylic acids containing 3 to 8 C atoms and unsaturated monovalent alcohols containing 3 to 12 C atoms, or saturated polyols containing 2 to 4 OH-groups and 2 to 20 C atoms, such as e.g. ethylene glycol dimethacrylate, allyl methacrylate; polyunsaturated heterocyclic compounds, such as e.g. trivinyl- and triallyl cyanurate; polyfunctional vinyl compounds, such as di- and trivinyl benzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloyl hexahydro-s-triazine, triallyl benzenes. The quantity of crosslinked monomers is preferably 0.02 to 5, in particular 0.05 to 2 wt.% in relation to grafting base ii).

It is advantageous to restrict the quantity of cyclic crosslinking monomers containing at least 3 ethylenically unsaturated groups to less than 1 wt.% of grafting base ii).

Preferred ‘other’ polymerisable, ethylenically unsaturated monomers, which may optionally be used in addition to the acrylic acid esters to produce grafting base ii) are e.g. acrylonitrile, styrene, α-methyl styrene, acrylamide, vinyl-C₁—C₆-alkyl ether, methyl methacrylate, butadiene. Preferred acrylate rubbers as grafting base ii) are emulsion polymers, which contain at least 60 wt.% gel.

Further suitable grafting bases according to ii) are silicone rubbers with graft-active sites, such as those disclosed in DE-OS 3 704 657, DE-OS 3 704 655, DE-OS 3 631 540 and DE-OS 3 631 539.

The gel content of grafting base ii) is determined at 25° C. in a suitable solvent (M. Hoffmann, H. Krömer, R. Kuhn, Polymeranalytik I und II, George Thieme-Verlag, Stuttgart 1977).

The average particle size d₅₀ is the diameter above and below which 50% respectively of the particles lie. It can be determined by ultracentrifugal measurement (W. Scholtan, H. Lange, Kolloid-Z. und Z. Polymere 250 (1972), 782- 796).

Particularly preferred polymers B.1 are e.g. ABS polymers (preferably produced by emulsion polymerisation) such as those disclosed e.g. in DE-A 2 035 390 (=U.S. Pat. No. 3,644, 574) or in DE-A 2 248 242 (=GB-PS 1 409 275) or in Ullmann, Enzyklopädie der Technischen Chemie, Vol. 19 (1980), p. 280 ff. The grafting base ii) generally contains at least 30 wt.%, preferably at least 40 wt.% gel (measured in toluene).

The graft copolymer B. 1 to be used according to the invention is preferably produced by redox initiation.

Suitable redox initiator systems according to the invention generally consist of an organic oxidising agent and a reducing agent, heavy metal ions optionally also being present in the reaction medium; the process is preferably carried out without heavy metal ions.

Suitable organic oxidising agents according to the invention are for example and preferably di-tert-butyl peroxide, cumene hydroperoxide, dicyclohexyl percarbonate, tert-butyl hydroperoxide, p-menthane hydroperoxide or mixtures of these, cumene hydroperoxide and tert-butyl hydroperoxide being preferred in particular. H₂O₂ may also be used.

Reducing agents that may be used according to the invention are preferably water- soluble compounds with a reducing action, preferably selected from the group of the salts of sulfinic acid, salts of sulfurous acid, sodium dithionite, sodium sulfite, sodium hyposulfite, sodium hydrogen sulfite, ascorbic acid and its salts, Rongalit® (sodium formaldehyde sulfoxylate), mono- and dihydroxy acetone, sugar (e.g. glucose or dextrose). It is also possible, in principle, to use e.g. iron(II) salts, such as e.g. iron(II) sulfate, tin(II) salts, such as e.g. tin(II) chloride, titanium(III) salts, such as titanium(III) sulfate; however such metal salts are preferably not used.

Particularly preferred reducing agents are dextrose, ascorbic acid (salts) or sodium formaldehyde sulfoxylate (Rongalit®C).

However, it is also possible in principle to produce the graft copolymer B.1 to be used according to the invention by persulfate initiation.

Suitable persulfate compounds according to the invention are ammonium peroxo disulfate, potassium peroxo disulfate, sodium peroxo disulfate or mixtures of these.

The vinyl monomers listed under i) are generally used to produce the vinyl (co)polymer component B.2.

Here, monomers i) are also preferably mixtures of
i1) 50 to 99 parts by weight vinyl aromatics and/or core-substituted vinyl aromatics (such as for example styrene, a-methylstyrene, p-methylstyrene, p- chloro styrene) and/or (meth)acrylic acid-(C₁—C₈)-alkyl esters (such as e.g. methyl methacrylate, ethyl methacrylate) and
i2) 1 to 50 parts by weight vinyl cyanide (unsaturated nitriles such as acrylonitrile and methacrylonitrile) and/or (meth)acrylic acid-(C₁—C₈)-alkyl esters (such as e.g. methyl methacrylate, n-butyl acrylate, t-butyl acrylate) and/or derivatives (such as anhydrides and imides) of unsaturated carboxylic acids (for example maleic acid anhydride and N-phenyl maleic imide).

Preferred monomers i1) are selected from at least one of the monomers styrene, α- methyl styrene and methyl methacrylate, preferred monomers i2) are selected from at least one of the monomers acrylonitrile, maleic acid anhydride and methyl methacrylate.

Particularly preferred monomers are i1) styrene and i2) acrylonitrile.

The vinyl (co)polymer component B.2 is produced by emulsion polymerisation. The method to be used for this is the prior art.

The graft polymers B.1 and the vinyl (co)polymer B.2 may be co-precipitated in any mix ratio. The weight ratio is preferably B.1:B.2 95:5 to 5:95, particularly preferably 90:10 to 25:75, most preferably 85:15 to 50:50.

Production of the Co-precipated Graft Polymer/Vinyl (Co)Polymer Products P The co-precipitation products to be used according to the invention are produced by blending at least one graft polymer B.1 in latex form with at least one vinyl (co)polymer B.2 in latex form, homogeneously combining the latices and working up the resulting graft polymer/vinyl (co)polymer mix product using known processes.

Examples of suitable working-up processes are e.g. precipitation of the mix product by the effects of aqueous electrolyte solutions such as e.g. solutions of salts (e.g. magnesium sulfate, calcium chloride, sodium chloride), solutions of acids (e.g. sulfuric acid, acetic acid) or mixtures of these, precipitation by the effects of cold (freezing-coagulation) or direct extraction of the co-precipitation product from the latex by spray drying.

When precipitating the graft polymer/vinyl (co)polymer mixture, a washing step (preferably with water) and a drying step (e.g. in a fluidised bed drier or a pneumatic dryer) is generally added.

A preferred working-up process after precipitation is the blending of the moist graft polymer/vinyl (co)polymer mixture with a thermoplastic resin melt in a kneader reactor, which is disclosed in EP-A 867 463. Details of this working-up method are also disclosed in EP-A 867 463. The mixtures of graft polymer/vinyl (co)polymer mixture and thermoplastic resin C (in particular styrene/acrylonitrile copolymer) obtained by this working-up method are preferably used for the production of the moulding compositions according to the invention.

Component C

Suitable thermoplastic resins according to Component C are vinyl (co)polymers. They are resinous, thermoplastic and rubber-free. These are polymers of at least one monomer from the group of vinyl aromatics, vinyl cyanides (unsaturated nitrites), (meth)acrylic acid-(C₁—C₈)-alkyl esters, unsaturated carboxylic acids and derivatives (such as anhydrides and imides) of unsaturated carboxylic acids. (Co)polymers of
C.1 50 to 99, preferably 60 to 80 parts by weight vinyl aromatics and/or core- substituted vinyl aromatics, such as for example styrene, a-methylstyrene, p- methylstyrene, p-chloro styrene) and/or (meth)acrylic acid-(C₁—C₋₈)-alkyl esters such as e.g. methyl methacrylate, ethyl methacrylate, and
C.2 1 to 50, preferably 20 to 40 parts by weight vinyl cyanides (unsaturated nitriles) such as acrylonitrile and methacrylonitrile and/or (meth)acrylic acid- (C₁—C₈)-alkyl esters (such as e.g. methyl methacrylate, n-butyl acrylate, t- butyl acrylate and/or unsaturated carboxylic acids (such as maleic acid) and/or derivatives (such as anhydrides and imides) of unsaturated carboxylic acids (for example maleic acid anhydride and N-phenyl maleimide)
   are particularly suitable.

The copolymer of styrene and acrylonitrile is preferred in particular.

The co-precipitation product B is most preferably present in dispersed form in a matrix of vinyl (co)polymer C, preferably in a styrene/acrylonitrile copolymer matrix. Here, the weight ratio B:C is 90:10 to 10:90, preferably 80:20 to 30:70, in particular 70:30 to 40:60.

In principle, it is also possible to combine the thermoplastic resin component A), the graft polymer/vinyl (co)polymer mixture obtained by co-precipitation of B.1 and B.2 and the vinyl (co)polymer component C) and, optionally, any additives, with each other in one compounding step in conventional compounding equipment and then to mix them and further process them with the other components in the conventional manner. Furthermore, it is also possible to mix the components B and C with the remaining components and additives and further process them separately.

In a preferred embodiment of the present invention, styrene/acrylonitrile copolymers are used both as component B.2 and as component C. In a particularly preferred embodiment, the acrylonitrile content of the styrene/acrylonitrile copolymers differs by 1 to 15 wt.%, preferably by 2 to 10 wt.% and in particular by 2.5 to 7.5 wt.%, component C preferably having a higher acrylonitrile content than component B.2.

Component D

The compositions may be provided with flame resistance by the addition of suitable additives. Examples of flame retardants are halogen compounds, for example based on chlorine and bromine, compounds containing phosphorus, and also silicon compounds, in particular silicone compounds.

Flame retardants are preferably used in a quantity of 1 to 18, in particular 2 to 16, parts by weight.

The compositions preferably contain phosphatic flame-retardants from the group of monomeric and oligomeric phosphites and phosphonates, phosphonate amines and phosphazenes, mixtures of several components selected from one or various of these groups being possible as flame retardants. Other phosphorus compounds not specifically mentioned here may also be used alone or in any combination with other flame retardants.

Preferred mono- and oligomeric phosphites or phosphonates are phosphorus compounds of the general formula (IV) 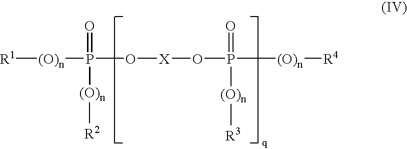
in which
R¹, R², R³ and R⁴, independently of each other mean in each case optionally halogenated C₁ to C₈-alkyl, C₅ to C₆-cycloalkyl in each case optionally substituted by alkyl, preferably C₁ to C₄-alkyl, and/or halogen, preferably chlorine, bromine, C₆ to C₂₀-aryl or C₇ to C₁₂-aralkyl,
n independently of each other, mean 0 or 1
q means 0 to 30 and
X may mean a mono- or polynuclear aromatic group containing 6 to 30 C atoms or a linear or branched aliphatic group containing 2 to 30 C atoms, which may be OH-substituted and may contain up to 8 ether bonds.
R¹, R², R³ and R⁴, independently of each other, preferably represent C₁ to C₄-alkyl, phenyl, naphthyl or phenyl-C₁—C₄-alkyl. The aromatic groups R¹, R², R³ and R⁴ may themselves be substituted with halogen and/or alkyl groups, preferably chlorine, bromine and/or C₁ to C₄-alkyl. Particularly preferred aryl groups are cresyl, phenyl, xylenyl, propylphenyl or butylphenyl as well as the corresponding brominated and chlorinated derivatives of these.
X in formula (IV) preferably means a mono- or polynuclear aromatic group containing 6 to 30 C atoms. This is preferably derived from diphenols of formula (I).
n in formula (IV) may, independently of each other, be 0 or 1; n is preferably equal to 1.
q represents values of 0 to 30, preferably 0.3 to 20, particularly preferably 0.5 to 10, in particular 0.5 to 6, most particularly 0.6 to 2.
X preferably represents

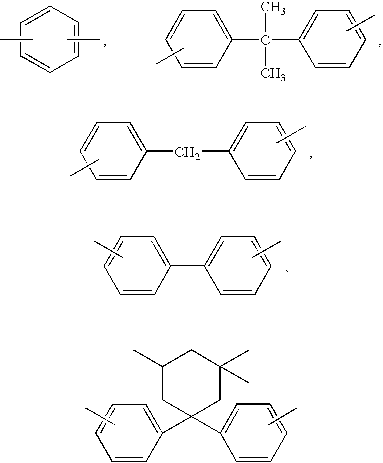

or chlorinated or brominated derivatives thereof; X is derived in particular from resorcinol, hydroquinone, bisphenol A or diphenyl phenol. X is derived particularly preferably from bisphenol A.

Mixtures of various phosphates may also be used as component D according to the invention.

Phosphorus compounds of formula (IV) are, in particular, tributyl phosphate, triphenyl phosphate, tricresyl phosphate, diphenyl cresyl phosphate, diphenyl octyl phosphate, diphenyl-2-ethyl cresyl phosphate, tri-(isopropyl phenyl)-phosphate, resorcinol-bridged diphosphate and bisphenol A-bridged diphosphate.

The phosphorus compounds according to component D are known (cf. e.g. EP-A 0 363 608, EP-A 0 640 655) or may be produced analogously by known methods (e.g. Ullmanns Enzyklopädie der technischen Chemie, Vol. 18, p. 301 ff. 1979; Houben- Weyl, Methoden der organischen Chemie, Vol. 12/1, p. 43; Beilstein Vol. 6, p. 177).

The average q values may be measured by determining the composition of the phosphate mixture (molecular weight distribution) using a suitable method (gas chromatography (GC), high pressure liquid chromatography (HPLC), gel permeation chromatography (GPC)) and calculating the average values for q from these.

Phosphonate amines and phosphazenes, such as those disclosed in WO 00/00541 and WO 01/18105 may also be used as flame retardants. The flame retardants may be used alone or in any mixture with each other or in mixture with other flame retardants.

Component E

The flame retardants according to component D are often used in combination with so-called anti-dripping agents, which reduce the tendency of the material to burning drip-off in the event of a fire. Examples of these are compounds of the substance classes of fluorinated polyolefins, silicones and aramide fibres. These may also be used in the compositions according to the invention. Fluorinated polyolefins are preferred as anti-dripping agents.

Fluorinated polyolefins are known and are disclosed for example in EP-A 0 640 655. They are marketed for example under the brand name Teflon® 30N by DuPont.

The fluorinated polyolefins may be used both in pure form and in the form of a coagulated mixture of emulsions of fluorinated polyolefins with emulsions of graft polymer (e.g. component B.1) or with an emulsion of a copolymer (e.g. component B.2), preferably based on styrene/acrylonitrile, the fluorinated polyolefin being mixed as an emulsion with an emulsion of the graft polymer or copolymer, and then coagulated.

The fluorinated polyolefins may also be used as a pre-compound with the graft polymer (component B.1) or a copolymer according to C, preferably based on styrene/acrylonitrile. The fluorinated polyolefins are mixed as a powder with a powder or granulate of the graft polymer or copolymer and compounded in the melt, generally at temperatures of 200 to 330° C., in conventional units such as internal kneaders, extruders or twin-shaft screws.

The fluorinated polyolefins may also be used in the form of a master batch, which is produced by emulsion polymerisation of at least one monoethylenically unsaturated monomer in the presence of an aqueous dispersion of the fluorinated polyolefin. Preferred monomer components are styrene, acrylonitrile and mixtures thereof. The polymer is used as a flowable powder after acid precipitation and subsequent drying.

The coagulates, pre-compounds or master batches normally contain 5 to 95 wt.%, preferably 7 to 60 wt.% fluorinated polyolefin solids.

The compositions according to the invention may contain anti-dripping agents in a quantity of preferably 0.01 to 3 parts by weight, particularly preferably 0.05 to 2 parts by weight and most preferably 0.1 to 0.8 parts by weight.

Component F (Other Additives)

The compositions according to the invention may further contain at least one of the conventional additives, such as mould lubricants and mould release agents, for example pentaerythritol tetrastearate, nucleation agents, anti-statics, stabilisers, fillers and reinforcing agents and also dyes and pigments.

All quantities by weight given in this application are standardised in such a way that the sum of the parts by weight of components A) to F) in the composition is equal to 100.

The compositions according to the invention are produced by combining the relevant components in the known way and melt compounding and melt extruding them at temperatures of 200 to 300° C. in conventional equipment such as internal kneaders, extruders and twin-shaft screws.

The individual components may be combined in the known way either successively or simultaneously, and either at 20° C. (room temperature) or at a higher temperature.

The moulding compositions according to the invention may be used for the production of moulded parts of all kinds. These may be produced by injection moulding, extrusion and blow moulding processes. A further processing method is the production of moulded parts by deep-drawing from previously-produced sheets or films and by the IMD process.

Examples of such moulded parts are films, profiles, casing components of all kinds, e.g. for domestic appliances such as juice extractors, coffee machines, food mixers; for office equipment such as monitors, printers, photocopiers; external and internal components for motor vehicles; disks, tubes, electrical installation ducts, windows, doors and other profiles for the building industry (internal fittings and external applications) as well as electrical and electronic components such as switches, plugs and plug sockets.

The moulding compositions according to the invention may be used in particular, for example, also for the production of the following moulded parts:

Internal components for rail vehicles, ships, aircraft, buses and other motor vehicles, bodywork parts for the motor vehicle sector, casings for electrical devices containing small transformers, cases for equipment used for the processing and dissemination of information, casings and linings for medical instruments, massage instruments and casings for them, toy vehicles for children, wall elements in sheet form, casings for safety equipment, heat-insulated transport containers, devices for holding and caring for small animals, moulded parts for sanitary ware and bathroom fittings, covering grilles for air vents, moulded parts for garden sheds and tool sheds, casings for garden tools.

The following examples serve to explain the invention further.

The invention thus provides also a process for the production of the compositions and their use for the production of moulded parts and the moulded parts themselves.

### EXAMPLES

In the following examples, the parts given are always parts by weight and the % given are always wt.% unless otherwise stated.

Components used:

Component A1

Linear polycarbonate based on bisphenol A with a relative solution viscosity of 1.28, measured in methylene chloride at 25° C. and at a concentration of 0.5 g/100 ml.

Component B1.1 (Reference Material)

Graft polymer produced by radical emulsion polymerisation (use of a redox initiator system of tert-butyl hydroperoxide and sodium ascorbate) of 40 parts by weight styrene and acrylonitrile in a weight ratio of 73:27 in the presence of 60 parts by weight of a crosslinked polybutadiene rubber latex in particle form (average particle size d₅₀₌345 nm), working up by precipitation under the influence of a magnesium sulfate/acetic acid=1:1 mixture, washing with water and drying at 70° C.

Component B2.1 (Reference Material)

Styrene/acrylonitrile copolymer (wt. ratio styrene:acrylonitrile=73:27), produced by radical emulsion polymerisation (use of potassium peroxo disulfate as the initiator) with an intrinsic viscosity of 0.59 dl/g (measured in dimethyl formamide at 20° C.).

Component B2.2 (Reference Material)

Styrene/acrylonitrile copolymer (wt. ratio styrene:acrylonitrile=76:24), produced by radical emulsion polymerisation (use of potassium peroxo disulfate as the initiator) with an intrinsic viscosity of 0.58 dl/g (measured in dimethyl formamide at 20° C.).

Co-precipitation Component B1.1/B2.1=80:20

(According to the Invention)

80 parts by weight (in relation to solids) of the graft polymer B1.1 in latex form and 20 parts by weight (in relation to solids) of the styrene/acrylonitrile copolymer B2.1 in latex form are mixed homogeneously; the latex mixture is then precipitated under the influence of a magnesium sulfate/acetic acid=1:1 mixture. After washing with water drying is carried out at 70° C.

Co-precipitation Component B1.1/B2.2=90:10

(According to the Invention)

90 parts by weight (in relation to solids) of the graft polymer B1.1 in latex form and 10 parts by weight (in relation to solids) of the styrene/acrylonitrile copolymer B2.2 in latex form are mixed homogeneously; the latex mixture is then precipitated under the influence of a magnesium sulfate/acetic acid=1:1 mixture. After washing with water drying is carried out at 70° C.

Co-precipitation Component B1.1/B2.2=80:20

(According to the Invention)

80 parts by weight (in relation to solids) of the graft polymer B1.1 in latex form and 20 parts by weight (in relation to solids) of the styrene/acrylonitrile copolymer B2.2 in latex form are mixed homogeneously; the latex mixture is then precipitated under the influence of a magnesium sulfate/acetic acid=1:1 mixture. After washing with water drying is carried out at 70° C.

Component C1

Styrene/acrylonitrile copolymer produced by radical solvent polymerisation with a styrene/acrylonitrile weight ratio of 72:28 and an intrinsic viscosity of 0.55 dl/g (measured in dimethyl formamide at 20° C.).

Component F1

Pentaerythritol tetrastearate.

Component F2

Phosphite stabiliser.

Production and Testing of the Moulding Compositions

The components used are mixed with the conventional processing auxiliary agents in a ZSK 25 twin-shaft extruder. The moulded bodies are produced on an Arburg 270 E injection moulding machine at 260° C.

Notched impact strength is measured at room temperature (aₖ^{RT}) and at −20° C. (aₖ^{-20°C.}) to ISO 180/1A (unit: kJ/m²).

The thermoplastic flowability MVR (melt volume flow rate) is measured to ISO 1133 (unit:cm^{3/}10 min).

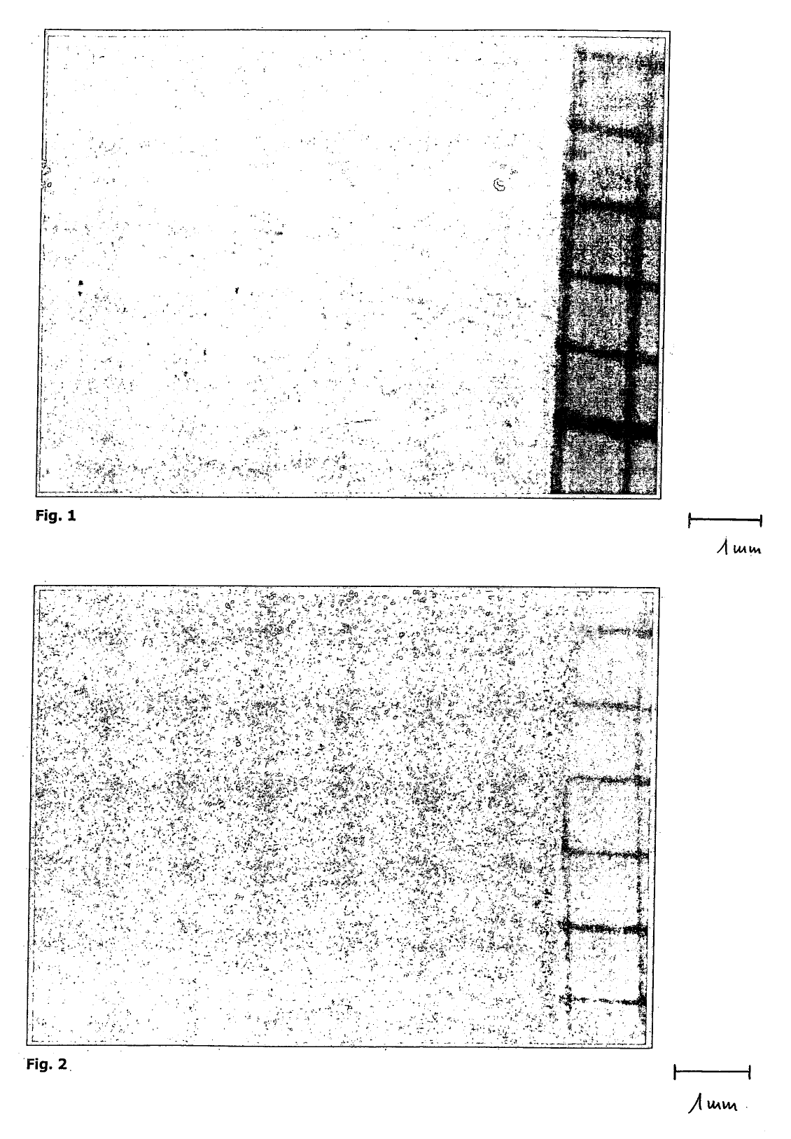

The surface is assessed visually on injection moulded sheets measuring 75×50×2 mm, the surface being inspected with the aid of a microscope. The surface quality can clearly be seen in FIG. 1 and FIG. 2. FIG. 1 shows a surface that represents the score ++, FIG. 2 the score −−.

The following classification is used:

++Very good surface quality, minimal number of small defects, no large defects.
+ Good surface quality, low number of small defects.
0 Average minimum number of large defects i.e. just acceptable surface quality, low number of small defects and low number of large defects.
− Poor surface quality, high number of small defects, significant number of large defects.
−− Very poor surface quality, very high number of small and large defects.

Defects according to the present invention are any deviations from a level and smooth surface, for example indentations (holes) or raised areas, rough surface.

As can be seen from table 1, the moulding compositions according to the invention produce a significantly improved surface quality, whilst maintaining the other properties such as e.g. toughness and thermoplastic flowability.

TABLE 1
Compositions and properties of the moulding compositions

| | Component (parts by weight | | | |
|---|---|---|---|---|
| | 1 | 2 | 3 | 4 (ref) |
| A1 | 43 | 43 | 43 | 43 |
| B1.1 | — | — | — | 24 |
| Co-precipitation B1.1/B2.1 = 80:20 | 30 | — | — | — |
| Co-precipitation B1.1/B2.2 = 90:10 | — | 26.6 | — | — |
| Co-precipitation B1.1/B2.2 = 80:20 | — | — | 30 | — |
| C1 | 27 | 30.4 | 27 | 33 |
| F1 | 0.75 | 0.75 | 0.75 | 0.75 |
| F2 | 0.15 | 0.15 | 0.15 | 0.15 |
| aₖ^{RT}(kJ/m²) | 86 | 86 | 84 | 87 |
| aₖ⁻²⁰(kJ/m²) | 59 | 58 | 69 | 56 |
| MVR (cm³/10 min) | 8.8 | 7.8 | 8.2 | 9.6 |
| Surface | ++ | + | ++ | −− |

1-20. (canceled)

21. A thermoplastic molding composition comprising
A) at least one member selected from the group consisting of polycarbonate, polyestercarbonate, polyamide, polyalkylene terephthalate and polyoxymethylene,
B) a co-precipitated mixture containing B.1 at least one emulsion polymerized graft polymer and B.2 at least one vinyl(co)polymer B.2 and
C) at least one rubber-free thermoplastic vinyl (co)polymer product of solution-, mass- or suspension polymerisation.

22. The composition of claim 21 wherein said A) is present in an amount of 10 to 99 parts by weight, B) is present in an amount of 0.5 to 90 parts by weight and C) is present in an amount of 1 to 50 parts by weight.

23. The composition of claim 22 further containing D) 0 to 20 parts by weight of at least one flame retardant, and E) 0 to 5 parts by weight of a fluorinated polyolefin.

24. The composition of claim 21, wherein said graft polymer is a product of emulsion polymerisation of
i) 5 to 95 wt.% of at least one vinyl monomer on
ii) 95 to 5 wt.% of one or more grafting bases having glass transition temperatures <10° C.
and where said B.2 is a product of emulsion polymerisation of at least one vinyl monomer.

25. The composition according to claim 24, wherein said i) is a mixture of
i1) 50 to 99 parts by weight of at least one member selected from the group consisting of vinyl aromatics, nucleus-substituted vinyl aromatics and (meth)acrylic acid-(C₁—C₈)-alkyl esters and
i2) 1 to 50 parts by weight of at least one member selected from the group consisting of vinyl cyanides, (meth)acrylic acid-(C₁—C₈)-alkyl esters and derivatives of unsaturated carboxylic acids.

26. The composition according to claim 25, wherein said i1) is a member selected from the group consisting of styrene, α-methyl styrene and methyl methacrylate and where i2) is a member selected from the group consisting of acrylonitrile, maleic acid anhydride and methyl methacrylate.

27. The composition according to claim 26, wherein monomer i1) is styrene and i2) is acrylonitrile.

28. The composition according to claim 24 wherein the grafting base is at least one member selected from the group consisting of diene rubber, EP(D)M rubber, acrylate-, polyurethane-, silicone-, chloroprene-, and ethylene/vinyl acetate rubber.

29. The composition of claim 24 wherein the grafting base is a diene rubber.

30. The composition according to claim 21 wherein the graft polymer B.1 and vinyl (co)polymer B.2 relate one to the other by weight as 90:10 to 25:75.

31. The composition according to claim 21, wherein the graft polymer B.1 and vinyl (co)polymer B.2 relate one to the other by weight as 85:15 to 50:50.

32. The composition according to claim 21, wherein the vinyl (co)polymer C) is a product of
i1) 50 to 99 parts by weight of at least one monomer selected from the group consisting of vinyl aromatics, nucleus-substituted vinyl aromatics, (meth)acrylic acid-(C₁—C₈)-alkyl esters and
i2) 1 to 50 parts by weight of at least one monomer selected from the group consisting of vinyl cyanides (meth)acrylic acid-(C₁—C₈)-alkyl esters, derivatives of unsaturated carboxylic acids.

33. The composition according to claim 21 wherein B) and C) relate one to the other by weight as 80:20 to 30:70.

34. The composition according to claim 24 wherein the content of grafting base is 75 to 40 wt.% in relation to the graft polymer.

35. The composition according to claim 23 wherein the flame retardant conforms to formula (IV) 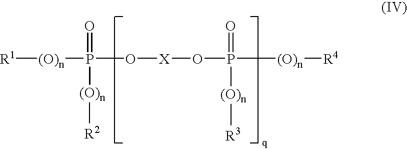
in which
R¹, R², R³ and R⁴, independently denote C₁ to C₈-alkyl, C₅ to C₆-cycloalkyl, C₆ to C₂₀-aryl or C₇ to C₁₂-aralkyl,
n independently of each other mean 0 or 1,
q means 0 to 30 and
X means a mono- or polynuclear aromatic group containing 6 to 30 C atoms or a linear or branched aliphatic group containing 2 to 30 C atoms, which are OH-substituted and may contain up to 8 ether bonds.

36. The composition of claim 35 wherein said R¹, R², R³ and R⁴, independently are halogen and/or alkyl substituted.

37. The composition according to claim 35, wherein q is 0 to 10,
X represents a member selected from the group consisting of 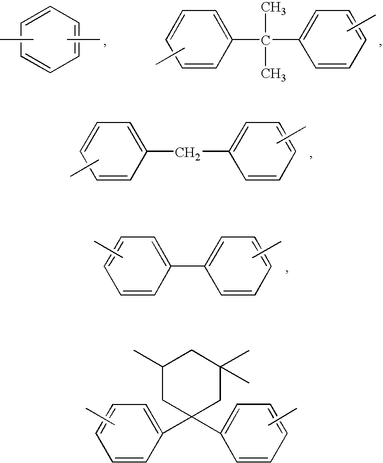
and n is 1.

38. The composition of claim 21 wherein both B.2 and C contain acrylonitrile and the acrylonitrile contents of B.2 and C differ by 1 to 15 wt.%.

39. The composition according to claim 21, wherein said A is selected from the group consisting of polycarbonate and polyamide.

40. The composition according to claim 21 further containing at least one member selected from the group consisting of mold lubricant, and mold release agent, nucleation agent, antistatic, stabilizer, filler, reinforcing agent, dye and pigment.

41. A molded article comprising the composition of claim 21.
